(19) United States
(12) Patent Application Publication
(10) Pub. No.: US 2025/0020926 A1
(43) Pub. Date: Jan. 16, 2025

(54) Electronic Devices with Tunable Lenses

(71) Applicant: Apple Inc., Cupertino, CA (US)

(72) Inventors: James E. Pedder, Oxon (GB); Igor Stamenov, San Ramon, CA (US); Arthur Y. Zhang, San Jose, CA (US)

(21) Appl. No.: 18/643,934

(22) Filed: Apr. 23, 2024

Related U.S. Application Data
(60) Provisional application No. 63/512,875, filed on Jul. 10, 2023.
(60) Provisional application No. 63/512,870, filed on Jul. 10, 2023.

(51) Int. Cl. G02B 27/01; G02B 3/12; G02B 25/00; G06F 1/16

(52) U.S. Cl. CPC G02B 27/0172; G02B 3/14; G02B 27/0179; G02B 2027/0187

(57) ABSTRACT

An electronic device may include an optical module with a display and a tunable lens. During operation, the electronic device may gather data and adjust the tunable lens based on the gathered data. The optical module may include a non-adjustable lens element with convex curvature in addition to the tunable lens. The optical module may include a Fresnel lens element in addition to the tunable lens. The optical module may include a catadioptric lens in addition to the tunable lens. The optical module may include a catadioptric lens that includes the tunable lens. The optical module may have a birdbath architecture that includes the tunable lens. The optical module may include a waveguide and the tunable lens may be an adjustable positive bias lens and/or an adjustable negative bias lens.

This application claims the benefit of U.S. provisional patent application No. 63/512,875filed Jul. 10, 2023, and U.S. provisional patent application No. 63/512,870, filed Jul. 10, 2023, which are hereby incorporated by reference herein in their entireties.

### BACKGROUND

This relates generally to electronic devices and, more particularly, to wearable electronic device systems.

Electronic devices are sometimes configured to be worn by users. For example, head-mounted devices are provided with head-mounted structures that allow the devices to be worn on users' heads. The head-mounted devices may include optical systems with lenses.

Head-mounted devices typically include lenses with fixed shapes and properties. If care is not taken, it may be difficult to adjust these types of lenses to optimally present content to each user of the head-mounted device.

### SUMMARY

An electronic device may include a head-mounted support structure, a lens module coupled to the head-mounted support structure and comprising a catadioptric lens and a tunable lens, and a display that is viewable through the lens module.

An electronic device may include a head-mounted support structure, a lens module coupled to the head-mounted support structure and comprising a tunable lens and a Fresnel lens element, and a display that is viewable through the lens module.

An electronic device may include a head-mounted support structure, a catadioptric lens module coupled to the head-mounted support structure and comprising a tunable lens element, a partially reflective layer, a quarter wave plate, and a reflective polarizer, and a display that is viewable through the catadioptric lens module.

An electronic device may include a head-mounted support structure and an optical module coupled to the head-mounted support structure. The optical module may include a waveguide having first and second opposing sides, a display that is configured to emit light into the waveguide, a negative bias lens on the first side of the waveguide, and an adjustable positive bias lens on the second side of the waveguide.

An electronic device may include a head-mounted support structure and an optical module coupled to the head-mounted support structure. The optical module may include a display, a partially reflective layer, a tunable lens element, and a reflective layer with a surface having concave curvature.

An electronic device may include a head-mounted support structure and an optical module coupled to the head-mounted support structure. The optical module may include a display, a partially reflective layer, and a tunable lens element that is interposed between the display and the partially reflective layer.

### BRIEF DESCRIPTION OF THE DRAWINGS

FIG. 1 is a schematic diagram of an illustrative electronic device in accordance with some embodiments.

FIG. 2 is a top view of an illustrative head-mounted device with a lens module in accordance with some embodiments.

FIG. 3 is a side view of an illustrative lens module in accordance with some embodiments.

FIGS. 4 and 5 are side views of an illustrative tunable lens in different tuning states in accordance with some embodiments.

FIG. 6 is a side view of an illustrative optical module with a tunable lens, a non-adjustable lens element having convex curvature, and a display in accordance with some embodiments.

FIG. 7 is a side view of an illustrative optical module with a tunable lens and a display in accordance with some embodiments.

FIG. 8 is a side view of an illustrative optical module with a tunable lens, a Fresnel lens element, and a display in accordance with some embodiments.

FIG. 9 is a side view of an illustrative optical module with a tunable lens that has an integrated Fresnel lens element in accordance with some embodiments.

FIG. 10 is a side view of an illustrative optical module with a tunable lens, a catadioptric lens that includes two lens elements, and a display in accordance with some embodiments.

FIG. 11 is a side view of an illustrative optical module with a tunable lens, a catadioptric lens that includes three lens elements, and a display in accordance with some embodiments.

FIG. 12 is a side view of an illustrative optical module with a tunable lens, a catadioptric lens that includes two lens elements separated by an air gap, and a display in accordance with some embodiments.

FIG. 13 is a side view of an illustrative optical module with a catadioptric lens that includes a tunable lens element in accordance with some embodiments.

FIG. 14 is a side view of an illustrative optical module with a birdbath architecture that includes a tunable lens in accordance with some embodiments.

FIG. 15 is a side view of an illustrative optical module with a tunable lens interposed between a display and a partially reflective layer in accordance with some embodiments.

FIG. 16 is a side view of an illustrative optical module with a waveguide, a non-adjustable negative bias lens, and an adjustable positive bias lens that directly contacts a cover layer in accordance with some embodiments.

FIG. 17 is a side view of an illustrative optical module with a waveguide, a non-adjustable negative bias lens, and an adjustable positive bias lens that is separated from a cover layer by an air gap in accordance with some embodiments.

FIG. 18 is a side view of an illustrative optical module with a waveguide, an adjustable negative bias lens, and an adjustable positive bias lens in accordance with some embodiments.

FIG. 19 is a side view of an illustrative optical module with a tunable lens having an aspheric concave surface and an adjustable convex surface in accordance with some embodiments.

FIG. 20 is a side view of an illustrative optical module with a tunable lens interposed between first and second additional lens elements and separated from the first and second additional lens elements by air gaps in accordance with some embodiments.

FIGS. 21A and 21B are side views of an illustrative optical module with a fluid control component that adjusts the thickness of a fluid-filled chamber in a tunable lens in accordance with some embodiments.

FIG. 22 is a side view of an illustrative optical module with an adjustable partially reflective layer in accordance with some embodiments.

FIG. 23 is a flowchart of an illustrative method for operating an electronic device with a tunable lens in accordance with some embodiments.

### DETAILED DESCRIPTION

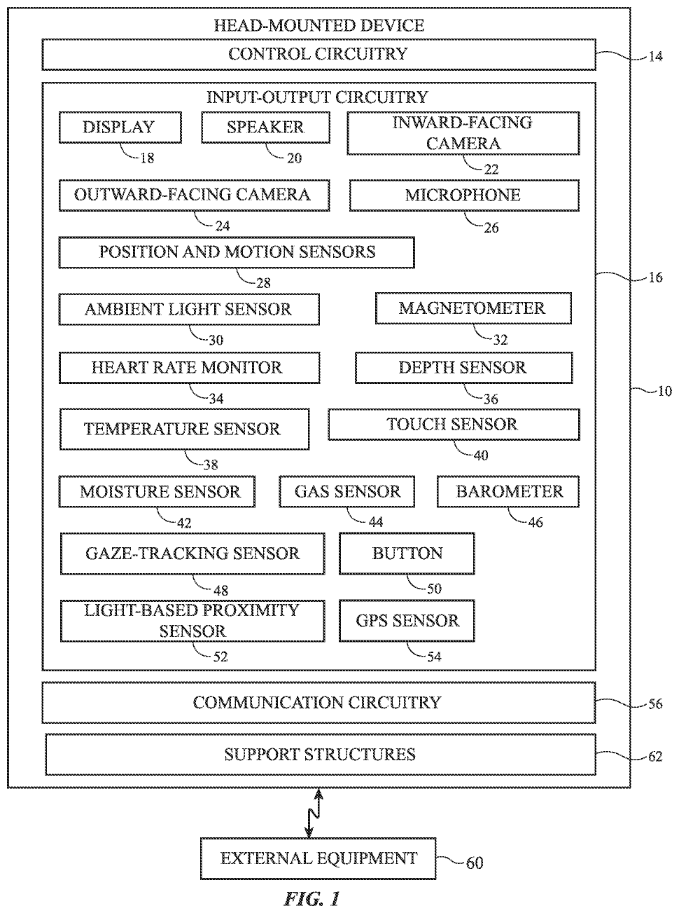

A schematic diagram of an illustrative electronic device is shown in FIG. 1. As shown in FIG. 1, electronic device 10 (sometimes referred to as head-mounted device 10, system 10, head-mounted display 10, etc.) may have control circuitry 14. In addition to being a head-mounted device, electronic device 10 may be other types of electronic devices such as a cellular telephone, laptop computer, speaker, computer monitor, electronic watch, tablet computer, etc. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 16. Input-output circuitry 16 may be used to allow a user to provide head-mounted device 10 with user input. Input-output circuitry 16 may also be used to gather information on the environment in which head-mounted device 10 is operating. Output components in circuitry 16 may allow head-mounted device 10 to provide a user with output.

As shown in FIG. 1, input-output circuitry 16 may include a display such as display 18. Display 18 may be used to display images for a user of head-mounted device 10. Display 18 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18 is opaque, the display may also optionally display entirely computer-generated content (e.g., without displaying images of the physical environment).

Display 18 may include one or more optical systems (e.g., lenses) (sometimes referred to as optical assemblies) that allow a viewer to view images on display(s) 18. A single display 18 may produce images for both eyes or a pair of displays 18 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

The example of device 10 including a display is merely illustrative and display(s) 18 may be omitted from device 10 if desired. Device 10 may include an optical pass-through area where real-world content is viewable to the user either directly or through a tunable lens.

Input-output circuitry 16 may include various other input-output devices. For example, input-output circuitry 16 may include one or more speakers 20 that are configured to play audio and one or more microphones 26 that are configured to capture audio data from the user and/or from the physical environment around the user.

Input-output circuitry 16 may also include one or more cameras such as an inward-facing camera 22 (e.g., that face the user's face when the head-mounted device is mounted on the user's head) and an outward-facing camera 24 (that face the physical environment around the user when the head-mounted device is mounted on the user's head). Cameras 22 and 24 may capture visible light images, infrared images, or images of any other desired type. The cameras may be stereo cameras if desired. Inward-facing camera 22 may capture images that are used for gaze-detection operations, in one possible arrangement. Outward-facing camera 24 may capture pass-through video for head-mounted device 10.

As shown in FIG. 1, input-output circuitry 16 may include position and motion sensors 28 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Using sensors 28, for example, control circuitry 14 can monitor the current direction in which a user's head is oriented relative to the surrounding environment (e.g., a user's head pose). One or more of cameras 22 and 24 may also be considered part of position and motion sensors 28. The cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 16 may also include other sensors and input-output components if desired. As shown in FIG. 1, input-output circuitry 16 may include an ambient light sensor 30. The ambient light sensor may be used to measure ambient light levels around head-mounted device 10. The ambient light sensor may measure light at one or more wavelengths (e.g., different colors of visible light and/or infrared light).

Input-output circuitry 16 may include a magnetometer 32. The magnetometer may be used to measure the strength and/or direction of magnetic fields around head-mounted device 10.

Input-output circuitry 16 may include a heart rate monitor 34. The heart rate monitor may be used to measure the heart rate of a user wearing head-mounted device 10 using any desired techniques.

Input-output circuitry 16 may include a depth sensor 36. The depth sensor may be a pixelated depth sensor (e.g., that is configured to measure multiple depths across the physical environment) or a point sensor (that is configured to measure a single depth in the physical environment). The depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 16 may include a temperature sensor 38. The temperature sensor may be used to measure the temperature of a user of head-mounted device 10, the temperature of head-mounted device 10 itself, or an ambient temperature of the physical environment around head-mounted device 10.

Input-output circuitry 16 may include a touch sensor 40. The touch sensor may be, for example, a capacitive touch sensor that is configured to detect touch from a user of the head-mounted device.

Input-output circuitry 16 may include a moisture sensor 42. The moisture sensor may be used to detect the presence of moisture (e.g., water) on, in, or around the head-mounted device.

Input-output circuitry 16 may include a gas sensor 44. The gas sensor may be used to detect the presence of one or more gases (e.g., smoke, carbon monoxide, etc.) in or around the head-mounted device.

Input-output circuitry 16 may include a barometer 46. The barometer may be used to measure atmospheric pressure, which may be used to determine the elevation above sea level of the head-mounted device.

Input-output circuitry 16 may include a gaze-tracking sensor 48 (sometimes referred to as gaze-tracker 48 and gaze-tracking system 48). The gaze-tracking sensor 48 may include a camera and/or other gaze-tracking sensor components (e.g., light sources that emit beams of light so that reflections of the beams from a user's eyes may be detected) to monitor the user's eyes. Gaze-tracker 48 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 48 is merely illustrative.

Input-output circuitry 16 may include a button 50. The button may include a mechanical switch that detects a user press during operation of the head-mounted device.

Input-output circuitry 16 may include a light-based proximity sensor 52. The light-based proximity sensor may include a light source (e.g., an infrared light source) and an image sensor (e.g., an infrared image sensor) configured to detect reflections of the emitted light to determine proximity to nearby objects.

Input-output circuitry 16 may include a global positioning system (GPS) sensor 54. The GPS sensor may determine location information for the head-mounted device. The GPS sensor may include one or more antennas used to receive GPS signals. The GPS sensor may be considered a part of position and motion sensors 28.

Input-output circuitry 16 may include any other desired components (e.g., capacitive proximity sensors, other proximity sensors, strain gauges, pressure sensors, audio components, haptic output devices such as vibration motors, light-emitting diodes, other light sources, etc.).

Head-mounted device 10 may also include communication circuitry 56 to allow the head-mounted device to communicate with external equipment (e.g., a tethered computer, a portable device such as a handheld device or laptop computer, one or more external servers, or other electrical equipment). Communication circuitry 56 may be used for both wired and wireless communication with external equipment.

Communication circuitry 56 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56 may handle wireless local area network (WLAN) communications bands such as the 2.4 GHZ and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHZ), a cellular low-midband (LMB) (e.g., 1400 to 1550 MHZ), a cellular midband (MB) (e.g., from 1700 to 2200 MHz), a cellular high band (HB) (e.g., from 2300 to 2700 MHZ), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHZ), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHZ and/or a second UWB communications band at 8.0 GHZ), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHZ and 40 GHz, a Kᵤ communications band between about 12 GHZ and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHZ), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

During operation, head-mounted device 10 may use communication circuitry 56 to communicate with external equipment 60. External equipment 60 may include one or more external servers, an electronic device that is paired with head-mounted device 10 (such as a cellular telephone, a laptop computer, a speaker, a computer monitor, an electronic watch, a tablet computer, earbuds, etc.), a vehicle, an internet of things (IoT) device (e.g., remote control, light switch, doorbell, lock, smoke alarm, light, thermostat, oven, refrigerator, stove, grill, coffee maker, toaster, microwave, etc.), etc.

Electronic device 10 may have housing structures (e.g., housing walls, straps, etc.), as shown by illustrative support structures 62 of FIG. 1. In configurations in which electronic device 10 is a head-mounted device (e.g., a pair of glasses, goggles, a helmet, a hat, etc.), support structures 62 may include head-mounted support structures (e.g., a helmet housing, head straps, temples in a pair of eyeglasses, goggle housing structures, and/or other head-mounted structures). The head-mounted support structures may be configured to be worn on a head of a user during operation of device 10 and may support control circuitry 14, input-output circuitry 16, and/or communication circuitry 56.

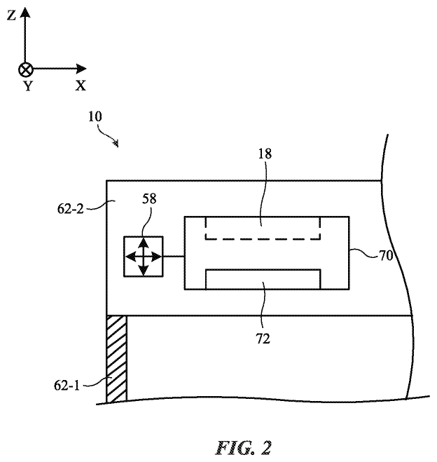

FIG. 2 is a top view of electronic device 10 in an illustrative configuration in which electronic device 10 is a head-mounted device. As shown in FIG. 2, electronic device 10 may include support structures (see, e.g., support structures 62 of FIG. 1) that are used in housing the components of device 10 and mounting device 10 onto a user's head. These support structures may include, for example, structures that form housing walls and other structures for main unit 62-2 (e.g., exterior housing walls, lens module structures, etc.) and eyeglass temples or other supplemental support structures such as structures 62-1 that help to hold main unit 62-2 on a user's face.

The electronic device may include optical modules such as optical module 70. The electronic device may include left and right optical modules that correspond respectively to a user's left eye and right eye. An optical module corresponding to the user's left eye is shown in FIG. 2.

Each optical module 70 includes a corresponding lens module 72 (sometimes referred to as lens stack-up 72, lens 72, or adjustable lens 72). Lens 72 may include one or more lens elements arranged along a common axis. Each lens element may have any desired shape and may be formed from any desired material (e.g., with any desired refractive index). The lens elements may have unique shapes and refractive indices that, in combination, focus light (e.g., from a display or from the physical environment) in a desired manner. Each lens element of lens module 72 may be formed from any desired material (e.g., glass, a polymer material such as polycarbonate or acrylic, a crystal such as sapphire, etc.).

Modules 70 may optionally be individually positioned relative to the user's eyes and relative to some of the housing wall structures of main unit 26-2 using positioning circuitry such as positioner 58. Positioner 58 may include stepper motors, piezoelectric actuators, motors, linear electromagnetic actuators, and/or other electronic components for adjusting the position of displays, the optical modules 70, and/or lens modules 72. Positioners 58 may be controlled by control circuitry 14 during operation of device 10. For example, positioners 58 may be used to adjust the spacing between modules 70 (and therefore the lens-to-lens spacing between the left and right lenses of modules 70) to match the interpupillary distance IPD of a user's eyes. In another example, the lens module may include an adjustable lens element. The curvature of the adjustable lens element may be adjusted in real time by positioner(s) 58 to compensate for a user's eyesight and/or viewing conditions.

Each optical module may optionally include a display such as display 18 in FIG. 2. As previously mentioned, the displays may be omitted from device 10 if desired. In this type of arrangement, the device may still include one or more lens modules 72 (e.g., through which the user views the real world). In this type of arrangement, real-world content may be selectively focused for a user.

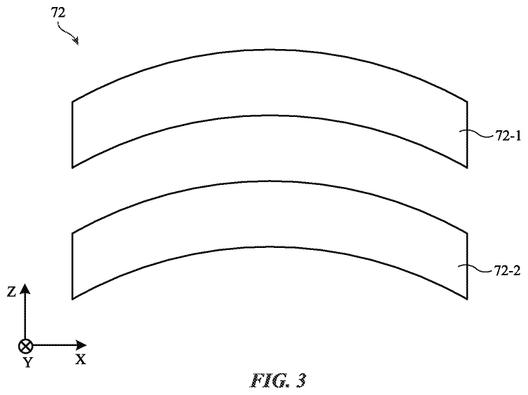

FIG. 3 is a cross-sectional side view of an illustrative lens module with multiple lens elements. As shown, lens module 72 includes a first lens element 72-1 and a second lens element 72-2. Each surface of the lens elements may have any desired curvature. For example, each surface may be a convex surface (e.g., a spherically convex surface, a cylindrically convex surface, or an aspherically convex surface), a concave surface (e.g., a spherically concave surface, a cylindrically concave surface, or an aspherically concave surface), a combination of convex and concave surfaces, or a freeform surface. A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In some cases, one of the lens surfaces may have an aspheric surface that changes from being convex (e.g., at the center) to concave (e.g., at the edges) at different positions on the surface. This type of surface may be referred to as an aspheric surface, a primarily convex (e.g., the majority of the surface is convex and/or the surface is convex at its center) aspheric surface, a freeform surface, and/or a primarily convex (e.g., the majority of the surface is convex and/or the surface is convex at its center) freeform surface. A freeform surface may include both convex and concave portions and/or curvatures defined by polynomial series and expansions. Alternatively, a freeform surface may have varying convex curvatures or varying concave curvatures (e.g., different portions with different radii of curvature, portions with curvature in one direction and different portions with curvature in two directions, etc.). Herein, a freeform surface that is primarily convex (e.g., the majority of the surface is convex and/or the surface is convex at its center) may sometimes still be referred to as a convex surface and a freeform surface that is primarily concave (e.g., the majority of the surface is concave and/or the surface is concave at its center) may sometimes still be referred to as a concave surface. In one example, shown in FIG. 3, lens element 72-1 has a convex surface that faces display 18 and an opposing concave surface. Lens element 72-2 has a convex surface that faces lens element 72-1 and an opposing concave surface.

One or both of lens elements 72-1 and 72-2 may be adjustable. In one example, lens element 72-1 is a non-adjustable lens element whereas lens element 72-2 is an adjustable lens element. The adjustable lens element 72-2 may be used to accommodate a user's eyeglass prescription, for example. The shape of lens element 72-2 may be adjusted if a user's eyeglass prescription changes (without needing to replace any of the other components within device 10). As another possible use case, a first user with a first eyeglass prescription (or no eyeglass prescription) may use device 10 with lens element 72-2 having a first shape and a second, different user with a second eyeglass prescription may use device 10 with lens element 72-2 having a second shape that is different than the first shape. Lens element 72-2 may have varying lens power and/or may provide varying amounts and orientations of astigmatism correction to provide prescription correction for the user.

The example of lens module 72 including two lens elements is merely illustrative. In general, lens module 72 may include any desired number of lens elements (e.g., one, two, three, four, more than four, etc.). Any subset or all of the lens elements may optionally be adjustable. Any of the adjustable lens elements in the lens module may optionally be fluid-filled adjustable lenses. Lens module 72 may also include any desired additional optical layers (e.g., partially reflective mirrors that reflect 50% of incident light, linear polarizers, retarders such as quarter wave plates, reflective polarizers, circular polarizers, reflective circular polarizers, etc.) to manipulate light that passes through lens module.

In one possible arrangement, lens element 72-1 may be a removable lens element. In other words, a user may be able to easily remove and replace lens element 72-1 within optical module 70. This may allow lens element 72-1 to be customizable. If lens element 72-1 is permanently affixed to the lens assembly, the lens power provided by lens element 72-1 cannot be easily changed. However, by making lens element 72-1 customizable, a user may select a lens element 72-1 that best suits their eyes and place the appropriate lens element 72-1 in the lens assembly. The lens element 72-1 may be used to accommodate a user's eyeglass prescription, for example. A user may replace lens element 72-1 with an updated lens element if their eyeglass prescription changes (without needing to replace any of the other components within electronic device 10). Lens element 72-1 may have varying lens power and/or may provide varying amount of astigmatism correction to provide prescription correction for the user. Lens element 72-1 may include one or more attachment structures that are configured to attach to corresponding attachment structures included in optical module 70, lens element 72-2, support structures 26, or another structure in electronic device 10.

In contrast with lens element 72-1, lens element 72-2 may not be a removable lens clement. Lens element 72-2 may therefore sometimes be referred to as a permanent lens element, non-removable lens element, etc. The example of lens element 72-2 being a non-removable lens clement is merely illustrative. In another possible arrangement, lens element 72-2 may also be a removable lens element (similar to lens element 72-1).

One or more of the adjustable lens elements may be a fluid-filled lens element. An example is described herein where lens element 72-2 from FIG. 3 is a fluid-filled lens element. When lens element 72-2 is a fluid-filled lens element, the lens element may include one or more components that define the surfaces of lens element 72-2. These elements may also be referred to as lens elements. In other words, adjustable lens element 72-2 (sometimes referred to as adjustable lens module 72-2, adjustable lens 72-2, tunable lens 72-2, etc.) may be formed by multiple respective lens elements.

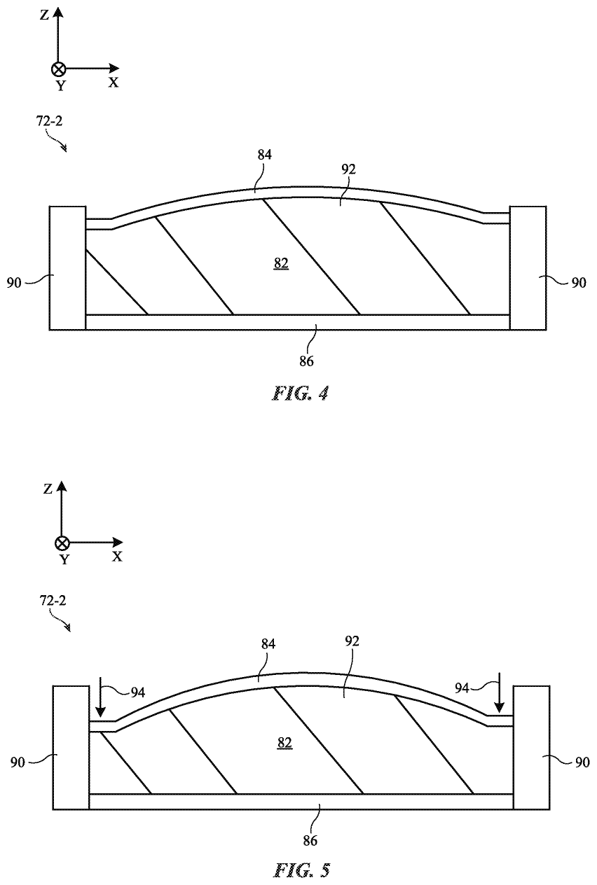

FIG. 4 is a cross-sectional side view of adjustable fluid-filled lens element 72-2. As shown, fluid-filled chamber 82 (sometimes referred to as chamber 82 or fluid chamber 82) that includes fluid 92 is interposed between lens elements 84 and 86. Fluid 92 may be a liquid, gel, or gas with a pre-determined index of refraction (and may therefore sometimes be referred to as liquid 92, gel 92, or gas 92). The fluid may sometimes be referred to as an index-matching oil, an optical oil, an optical fluid, an index-matching material, an index-matching liquid, etc. Lens elements 84 and 86 may have the same index of refraction or may have different indices of refraction. Fluid 92 that fills chamber 82 between lens elements 84 and 86 may have an index of refraction that is the same as the index of refraction of lens element 84 but different from the index of refraction of lens element 86, may have an index of refraction that is the same as the index of refraction of lens element 86 but different from the index of refraction of lens element 84, may have an index of refraction that is the same as the index of refraction of lens element 84 and lens element 86, or may have an index of refraction that is different from the index of refraction of lens element 84 and lens element 86. Lens elements 84 and 86 may have a circular footprint, may have an elliptical footprint, may have or may have a footprint any another desired shape (e.g., an irregular footprint).

The amount of fluid 92 in chamber 82 may have a constant volume or an adjustable volume. If the amount of fluid is adjustable, the lens module may also include a fluid reservoir and a fluid controlling component (e.g., a pump, stepper motor, piezoelectric actuator, motor, linear electromagnetic actuator, and/or other electronic component that applies a force to the fluid in the fluid reservoir) for selectively transferring fluid between the fluid reservoir and the chamber.

Lens elements 84 and 86 may be transparent lens elements formed from any desired material (e.g., glass, a polymer material such as polycarbonate or acrylic, a crystal such as sapphire, etc.). Each one of lens elements 84 and 86 may be elastomeric, semi-rigid, or rigid. Elastomeric lens elements may be formed from a natural or synthetic polymer that has a low Young's modulus for high flexibility. For example the elastomeric membrane may be formed from a material having a Young's modulus of less than 1 GPa, less than 0.5 GPa, less than 0.1 GPa, etc.

Semi-rigid lens elements may be formed from a semi-rigid material that is stiff and solid, but not inflexible. A semi-rigid lens element may, for example, be formed from a thin layer of polymer or glass. Semi-rigid lens elements may be formed from a material having a Young's modulus that is greater than 1 Gpa, greater than 2 GPa, greater than 3 GPa, greater than 10 GPa, greater than 25 GPa, etc. Semi-rigid lens elements may be formed from polycarbonate, polyethylene terephthalate (PET), polymethylmethacrylate (PMMA), acrylic, glass, or any other desired material. The properties of semi-rigid lens elements may result in the lens element becoming rigid along a first axis when the lens element is curved along a second axis perpendicular to the first axis or, more generally, for the product of the curvature along its two principal axes of curvature to remain roughly constant as it flexes. This is in contrast to an elastomeric lens element, which remains flexible along a first axis even when the lens element is curved along a second axis perpendicular to the first axis. The properties of semi-rigid lens elements may allow the semi-rigid lens elements to form a cylindrical lens with tunable lens power and a tunable axis.

Rigid lens elements may be formed from glass, a polymer material such as polycarbonate or acrylic, a crystal such as sapphire, etc. In general, the rigid lens elements may not deform when pressure is applied to the lens elements within the lens module. In other words, the shape and position of the rigid lens elements may be fixed. Each surface of a rigid lens element may be planar, concave (e.g., spherically, aspherically, or cylindrically concave), or convex (e.g., spherically, aspherically, or cylindrically convex). Rigid lens elements may be formed from a material having a Young's modulus that is greater than greater than 25 GPa, greater than 30 GPa, greater than 40 GPa, greater than 50 GPa, etc.

One or more structures such as a lens housing 90 (sometimes referred to as housing 90, lens chassis 90, chassis 90, support structure 90, etc.) may also define the fluid-filled chamber 82 of lens element 72-2.

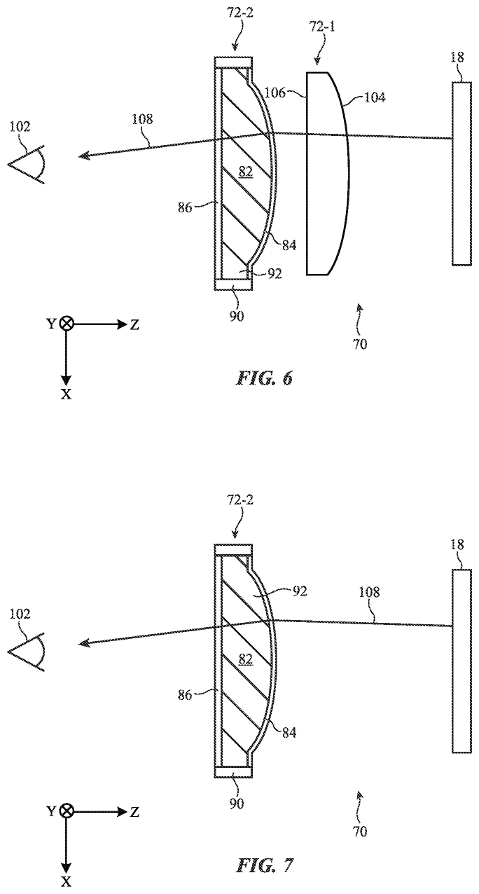

FIG. 5 is a cross-sectional side view of lens element 72-2 showing an illustrative adjustment of the shape of lens element 72-2. As shown, during adjustments of lens element 72-2, lens element 84 may be biased in direction 94 at multiple points along its periphery (e.g., a point force is applied in direction 94 at multiple points). In this way, the curvature of the lens element 84 (and accordingly, the lens power of lens element 72-2) may be adjusted. In one example, the curvature of lens element 84 is adjusted while the curvature of lens element 86 remains constant. Instead or in addition, the lens element 86 may be biased at multiple points along its periphery to adjust the curvature of lens element 86.

There are multiple options for how to manipulate the shape of lens element 84. In one possible arrangement, a plurality of actuators (e.g., linear actuators) may be coupled to the periphery of the lens element. The actuators may be distributed evenly around the periphery of the lens element 84, as one example. Each actuator (e.g., a linear actuator) may be coupled to a respective portion of lens element 84 and may selectively move that respective portion of lens clement 84 up and down (e.g., in the Z-direction in FIGS. 4 and 5) to control the position of that respective portion of lens element 84 in the Z-direction. A lens shaping element (e.g., a ring-shaped element) may optionally be coupled to both lens element 84 and the actuators.

The example of tunable lens element 72-2 being a fluid-filled lens element is merely illustrative. In general, tunable lens element 72-2 may be any desired type of tunable lens element with adjustable optical power.

A tunable lens element may be incorporated into a number of different types of optical modules. The tunable lens element may be used in virtual reality optical modules (in which an opaque display is viewed through the tunable lens element) and/or augmented reality optical modules (in which the real world is viewed in parallel with display content).

FIG. 6 is a side view of an optical module 70 with a tunable lens 72-2 and a lens element 72-1 that is non-adjustable. Tunable lens 72-2 may have the arrangement of FIGS. 4 and 5 or any other desired arrangement. The optical module also includes a display 18. Display 18 may emit light 108 through lens elements 72-1 and 72-2 towards viewer 102 (e.g., a viewer's eye, sometimes referred to as an eye-box). Display 18 may be opaque (e.g., with a transparency that is less than 40%, less than 20%, less than 10%, less than 10%, etc.).

In FIG. 6, non-adjustable lens 72-1 has a convex surface 104 and a planar surface 106. This example is merely illustrative. In general, each surface of the non-adjustable lens 72-1 may have any desired shape. The non-adjustable lens 72-1 may be formed from a single piece of glass or plastic, as examples.

In FIG. 6, lens element 72-1 is interposed between display 18 and tunable lens 72-2. This example is merely illustrative and lens elements 72-1 and 72-2 may be switched if desired (e.g., such that tunable lens element 72-2 is interposed between non-adjustable lens element 72-1 and display 18).

The non-adjustable lens element 72-1 in FIG. 6 may magnify the images from display 18 for viewer 102. In other words, non-adjustable lens element 72-1 may have a positive optical power that is fixed. Tunable lens 72-2 may be adjusted between any desired optical powers. The optical power of tunable lens 72-2 may be adjusted between different negative optical powers, may be adjusted between different positive optical powers, or may be adjusted between both positive and negative optical powers.

The example in FIG. 6 of a single non-adjustable lens element 72-1 being included is merely illustrative. In general, one or more non-adjustable lens elements may be included. For example, two non-adjustable lens elements that are collectively referred to as a doublet may be included, three non-adjustable lens elements that are collectively referred to as a triplet may be included, etc.

In another possible arrangement, shown in FIG. 7, the non-adjustable lens element 72-1 may be omitted from optical module 70. As shown in FIG. 7, tunable lens element 72-2 is the only lens element between display 18 and viewer 102. Tunable lens 72-2 may have the arrangement of FIGS. 4 and 5 or any other desired arrangement. Display 18 may emit light 108 through lens element 72-2 towards viewer 102. Display 18 may be opaque (e.g., with a transparency that is less than 40%, less than 20%, less than 10%, less than 10%, etc.).

The adjustable lens element 72-2 in FIG. 7 may magnify the images from display 18 for viewer 102. In other words, the optical power of tunable lens 72-2 may be adjusted between different positive optical powers.

FIG. 8 is a side view of an optical module 70 with a tunable lens 72-2 and a Fresnel lens element 72-1 that is non-adjustable. Tunable lens 72-2 may have the arrangement of FIGS. 4 and 5 or any other desired arrangement. The optical module also includes a display 18. Display 18 may emit light 108 through lens elements 72-1 and 72-2 towards viewer 102 (e.g., a viewer's eye, sometimes referred to as an eye-box). Display 18 may be opaque (e.g., with a transparency that is less than 40%, less than 20%, less than 10%, less than 10%, etc.).

In FIG. 8, non-adjustable lens 72-1 is a Fresnel lens. Fresnel lens 72-1 is characterized by slope facets 110 and draft facets 114. Facets 110 and 114 are formed from the surfaces of ring-shaped Fresnel lens portions such as concentric Fresnel lens rings 112. There may be any suitable number of rings 112 in Fresnel lens 72-1 (e.g., 50, 10-100, at least 5, at least 10, at least 15, at least 20, at least 30, at least 45, at least 75, fewer than 200, fewer than 150, or other suitable number). Slope facets 110 have a curved lens-shaped profile and exhibit relatively small angles (e.g., less than 45°, less than 30°, less than 20°, 0-20°, 0-30°, 0-40°, at least 2°, etc.) with respect to lateral dimensions such as the X-axis. Draft facets 114, which may have straight cross-sectional profiles, typically have relatively small angles (e.g., 2°) with respect to the Z-axis. The Z-axis is normal to the plane of the surface of lens 72-1 and is therefore orthogonal to the X-axis. The Z-axis may be referred to as the optical axis of the lens and may be referred to as a vertical dimension. Because of these orientations, draft facets 114 may sometimes be referred to as vertically extending facets and slope facets 110 may sometimes be referred to as horizontally extending or laterally extending facets (where the angle is less than 45 degrees from the plane of the lens). Fresnel lens element 72-1 may be formed from a single piece of glass or plastic, as examples.

In FIG. 8, Fresnel lens element 72-1 is interposed between display 18 and tunable lens 72-2. This example is merely illustrative and lens elements 72-1 and 72-2 may be switched if desired (e.g., such that tunable lens element 72-2 is interposed between Fresnel lens element 72-1 and display 18).

The Fresnel lens element 72-1 in FIG. 8 may magnify the images from display 18 for viewer 102. In other words, Fresnel lens element 72-1 may have a positive optical power that is fixed. Tunable lens 72-2 may be adjusted between any desired optical powers. The optical power of tunable lens 72-2 may be adjusted between different negative optical powers, may be adjusted between different positive optical powers, or may be adjusted between both positive and negative optical powers.

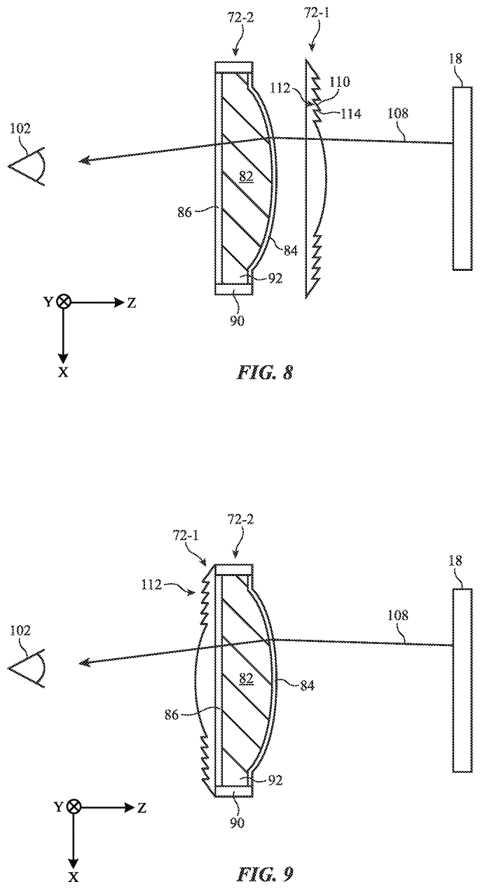

In another possible arrangement, shown in FIG. 9, the Fresnel lens element 72-1 may be integrated with tunable lens element 72-2. As shown in FIG. 9, Fresnel lens element 72-1 may be formed in direct contact with lens element 86 that defines a fluid-filled chamber 82 for tunable lens element 72-2. In other words, lens element 86 has a first side that is in direct contact with Fresnel lens element 72-1 and a second, opposing side that is in direct contact with fluid 92 in fluid-filled chamber 82.

If desired, lens element 86 may be omitted and Fresnel lens element 72-1 may define a fluid-filled chamber 82 for tunable lens element 72-2. In other words, Fresnel lens element 72-1 may be in direct contact with fluid 92 in fluid-filled chamber 82. The Fresnel lens element 72-1 may have a first side with Fresnel rings 112 and a second, opposing side that is planar. The planar side of the Fresnel lens element may be in direct contact with lens element 86 (or fluid 92 if lens element 86 is omitted).

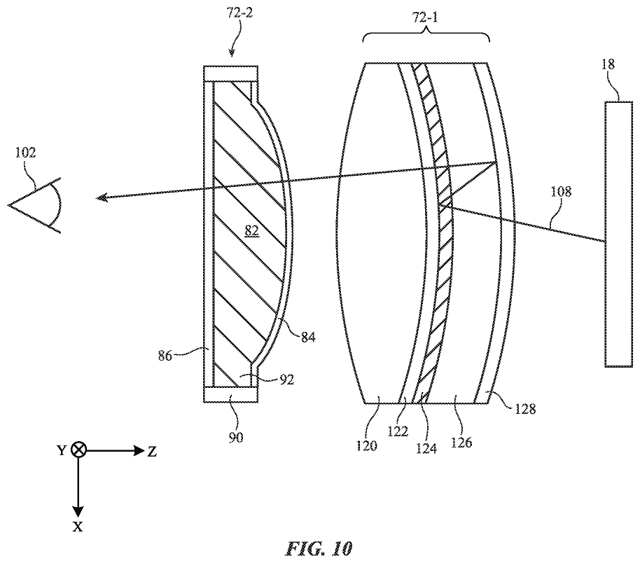

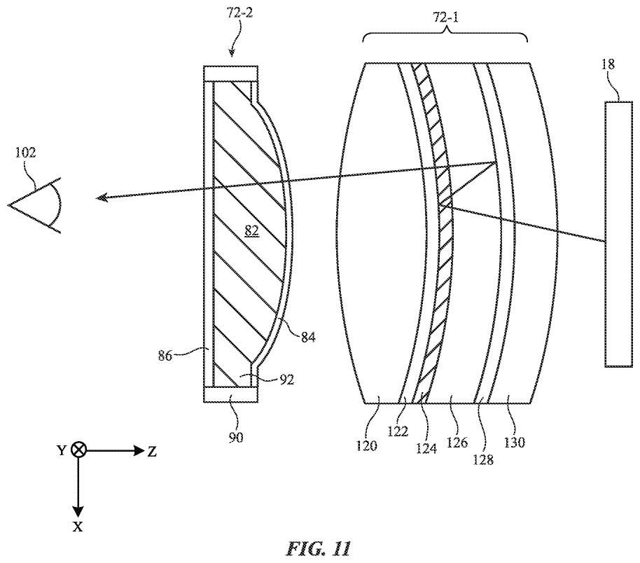

FIG. 10 is a side view of an optical module 70 with a tunable lens 72-2 and a catadioptric lens element 72-1 that is non-adjustable. Tunable lens 72-2 may have the arrangement of FIGS. 4 and 5 or any other desired arrangement. The optical module also includes a display 18. Display 18 may emit light 108 through lens elements 72-1 and 72-2 towards viewer 102 (e.g., a viewer's eye, sometimes referred to as an eye-box). Display 18 may be opaque (e.g., with a transparency that is less than 40%, less than 20%, less than 10%, less than 10%, etc.).

In general, catadioptric lens 72-1 may include optical structures such as partially reflective coatings, wave plates, reflective polarizers, linear polarizers, antireflection coatings, cholesteric liquid crystal layers, and/or other optical components. These optical structures may allow light rays from display 18 to pass through and/or reflect from surfaces in lens 72-1, thereby providing a desired lens power. In FIG. 10, non-adjustable lens 72-1 includes lens elements 120 and 126, a reflective polarizer 122, a quarter wave plate 124, and a partially reflective layer 128.

As shown in FIG. 10, a partially reflective mirror (e.g., a metal mirror coating or other mirror coating such as a dielectric multilayer coating with a 50% transmission and a 50% reflection) such as partially reflective mirror 128 may be formed on the convex surface of lens clement 126. Partially reflective mirror 128 may sometimes be referred to as beam splitter 128, half mirror (HM) 128, partially reflective layer 128, etc. Partially reflective layer 128 may have a reflectance that is greater than 20%, greater than 40%, less than 80%, less than 60%, between 40% and 60%, etc.

A wave plate such as wave plate 124 may be formed on the concave surface of lens element 126. Wave plate 124 may be attached to lens element 126 (e.g., using an optically clear adhesive layer or via coating directly to the lens element without an intervening adhesive layer). Wave plate 124 (sometimes referred to as retarder 124, quarter wave plate (QWP) 124, etc.) may be a quarter wave plate that conforms to the concave surface of lens element 126. Retarder 124 may be a coating on the concave surface of lens element 126.

Reflective polarizer 122 may be attached to retarder 124 (e.g., using an optically clear adhesive layer or via coating directly to the retarder without an intervening adhesive layer). Reflective polarizer 122 may have orthogonal reflection and pass axes. Light that is polarized parallel to the reflection axis of reflective polarizer 122 will be reflected by reflective polarizer 122. Light that is polarized perpendicular to the reflection axis and therefore parallel to the pass axis of reflective polarizer 122 will pass through reflective polarizer 122. Reflective polarizer 122 may sometimes be referred to as an advanced polarization film (APF).

As shown in FIG. 10, light 108 from display 18 may pass through partially reflective layer 128, lens element 126, and quarter wave plate 124 in that order before being reflected by reflective polarizer 122. The light reflected by reflective polarizer 122 passes through quarter wave plate 124 and lens element 126 in that order before being reflected by partially reflective layer 128. The light reflected by partially reflective layer 128 then passes through lens element 126, quarter wave plate 124, reflective polarizer 122, lens element 120, and tunable lens element 72-2 in that order to reach viewer 102.

In the example of FIG. 10, lens element 126 has one convex surface and one concave surface whereas lens element 120 has two convex surfaces. This example is merely illustrative and in general each surface of each lens element may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface. Different surfaces of the same lens element may have different radii of curvature. Different surfaces of different lens elements may have different radii of curvature. Each one of lens elements 120 and 126 may be formed from a transparent material such as plastic or glass.

Additional optical layers may be incorporated into catadioptric lens element 72-1 if desired. As a specific example, a linear polarizer may be included (e.g., between lens element 120 and tunable lens element 72-2 or between reflective polarizer 122 and lens element 120).

In FIG. 10, catadioptric lens element 72-1 is interposed between display 18 and tunable lens 72-2. This example is merely illustrative and lens elements 72-1 and 72-2 may be switched if desired (e.g., such that tunable lens element 72-2 is interposed between catadioptric lens clement 72-1 and display 18).

The catadioptric lens element 72-1 in FIG. 10 may magnify the images from display 18 for viewer 102. In other words, catadioptric lens element 72-1 may have a positive optical power that is fixed. Tunable lens 72-2 may be adjusted between any desired optical powers. The optical power of tunable lens 72-2 may be adjusted between different negative optical powers, may be adjusted between different positive optical powers, or may be adjusted between both positive and negative optical powers.

In the example of FIG. 10, catadioptric lens element 72-1 includes two lens elements. This example is merely illustrative. Lens element 120 may be omitted from the catadioptric lens element of FIG. 10 if desired. Alternatively, the catadioptric lens element 72-1 may include three lens elements. FIG. 11 shows an example where catadioptric lens element 72-1 includes lens element 130 in addition to lens elements 120 and 126. Lens element 130 is interposed between partially reflective layer 128 and display 18. The other components in catadioptric lens 72-1 of FIG. 11 are otherwise the same as in FIG. 10.

In the example of FIG. 11, lens element 130 has one convex surface and one concave surface. This example is merely illustrative and in general each surface of lens element 130 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface. Different surfaces of lens element 130 may have different radii of curvature. Lens elements 130 may be formed from a transparent material such as plastic or glass.

In FIG. 11, as in FIG. 10, tunable lens element 72-2 may instead be interposed between catadioptric lens 72-1 and display 18 if desired.

In FIGS. 10 and 11, quarter wave plate 124 may alternatively be positioned between lens element 126 and partially reflective layer 128.

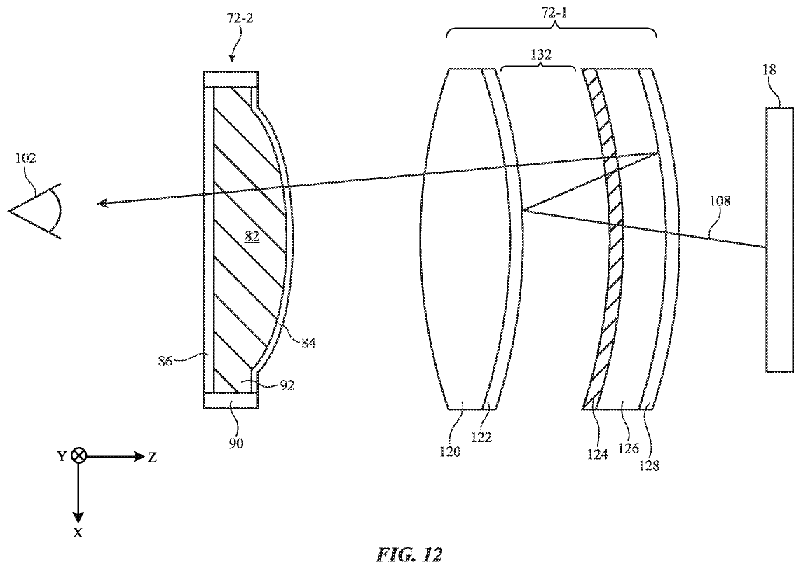

In yet another possible arrangement, shown in FIG. 12, the catadioptric lens 72-1 may be a dialyte-type catadioptric lens with an air gap 132 between lens elements 120 and 126. The function of catadioptric lens 72-1 in FIG. 12 is otherwise the same as the catadioptric lens in FIG. 10. In FIG. 12, reflective polarizer 122 is formed on lens element 120 between lens element 120 and quarter wave plate 124 and quarter wave plate 124 is formed on lens element 126 between reflective polarizer 122 and lens element 126. This example is merely illustrative. The reflective polarizer may instead be formed on lens element 126 if desired. Similarly, the quarter wave plate 124 may instead be formed on lens element 120 if desired. The quarter wave plate 124 may instead be formed between lens element 126 and partially reflective layer 128 if desired.

In FIG. 12, as in FIG. 10, tunable lens element 72-2 may instead be interposed between catadioptric lens 72-1 and display 18 if desired.

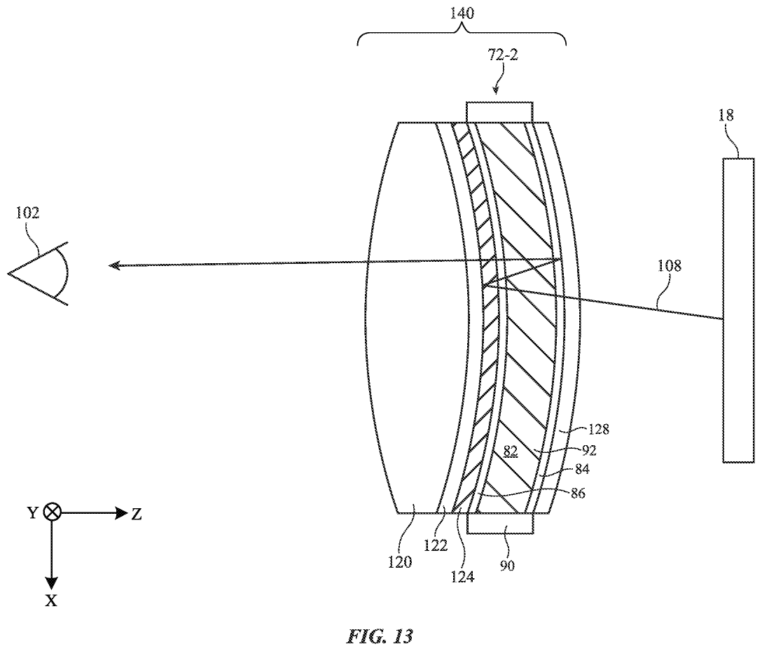

In another possible arrangement, one or more non-adjustable lenses in a catadioptric lens may be replaced with a tunable lens. For example, any of lens elements 120, 126, and 130 in FIGS. 10-12 may be replaced with tunable lens element 72-2 if desired. FIG. 13 is a side view of one example in which non-adjustable lens 126 from FIG. 10 has been replaced with tunable lens 72-2.

As shown in FIG. 13, catadioptric lens 140 includes lens element 120, reflective polarizer 122, quarter wave plate 124, tunable lens element 72-2, and partially reflective layer 128. Tunable lens 72-2 may have the arrangement of FIGS. 4 and 5 or any other desired arrangement.

Quarter wave plate 124 may be in direct contact with lens element 86 of lens element 72-2. This example is merely illustrative. If desired, lens element 86 may be omitted and quarter wave plate 124 may define fluid-filled chamber 82 and directly contact fluid 92. In other words, in FIG. 13 quarter wave plate 124 has a first side that directly contacts reflective polarizer 122 and a second, opposing side that directly contacts lens element 86 of tunable lens element 72-2. Alternatively, quarter wave plate 124 may have a first side that directly contacts reflective polarizer 122 and a second, opposing side that directly contacts fluid 92 of tunable lens element 72-2.

Partially reflective layer 128 may be in direct contact with lens element 84 of lens element 72-2. This example is merely illustrative. If desired, lens element 84 may be omitted and partially reflective layer 128 may define fluid-filled chamber 82 and directly contact fluid 92. In other words, in FIG. 13 partially reflective layer 128 has a first side that faces display 18 and a second, opposing side that directly contacts lens element 84 of tunable lens element 72-2. Alternatively, partially reflective layer 128 may have a first side that faces display 18 and a second, opposing side that directly contacts fluid 92 of tunable lens element 72-2.

As shown in FIG. 13, light 108 from display 18 may pass through partially reflective layer 128, lens element 84, fluid 82, lens element 86, and quarter wave plate 124 in that order before being reflected by reflective polarizer 122. The light reflected by reflective polarizer passes through quarter wave plate 124, lens element 86, fluid 82, and lens element 84 in that order before being reflected by partially reflective layer 128. The light reflected by partially reflective layer 128 then passes through lens element 84, fluid 82, lens element 86, quarter wave plate 124, reflective polarizer 122, and lens element 120 in that order to reach viewer 102. In other words, the light may make multiple passes through tunable lens 72-2 before reaching viewer 102.

In FIG. 13, the shape of lens element 84 in tunable lens 72-2 may be adjusted. This example is merely illustrative. If desired, the shape of lens element 86 in tunable lens 72-2 may be adjusted instead or in addition to the shape of lens element 84.

When a tunable lens element is used in a catadioptric lens, any of the optical layers described herein may optionally define the fluid-filled chamber of the tunable lens element and may directly contact the fluid in the tunable lens element. For example, reflective polarizer 122 may directly contact the fluid in the tunable lens element if lens element 120 is replaced with a tunable lens element. An optional linear polarizer in the catadioptric lens may directly contact the fluid in the tunable lens element if desired.

For each one of FIGS. 10-13, the lens module may collectively be referred to as a catadioptric lens module 72 due to the optical components in the lens module causing both refraction and reflection of light.

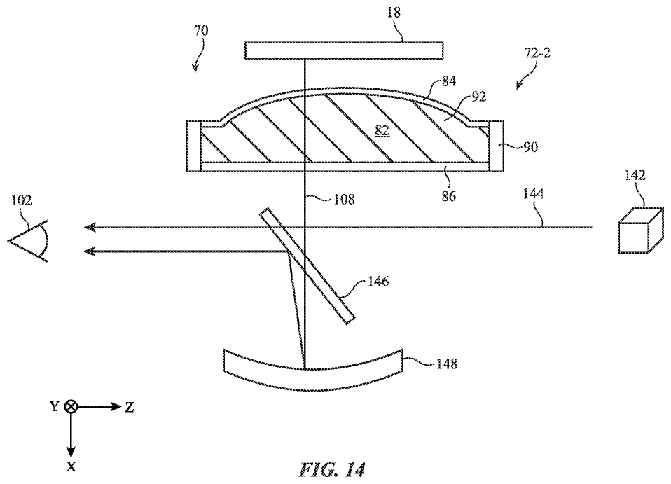

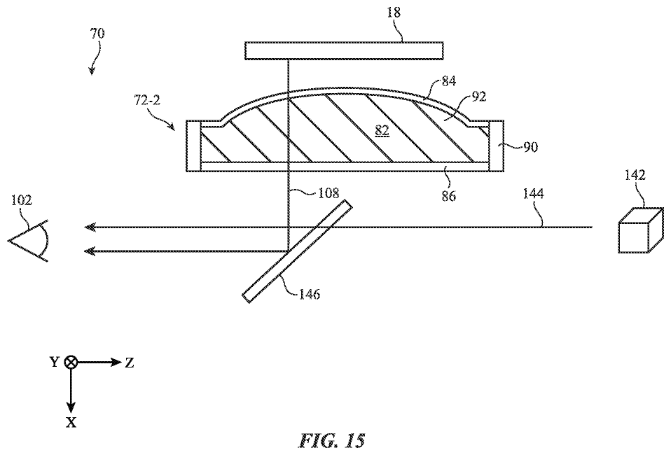

FIG. 14 is a side view of an optical module with a birdbath architecture that includes a tunable lens. As shown in FIG. 14, optical module 70 includes a display 18, tunable lens 72-2, a partially reflective layer 146, and a reflective layer 148.

Display 18 may emit light 108 through lens elements 72-2 towards partially reflective layer 146. Display 18 may be opaque (e.g., with a transparency that is less than 40%, less than 20%, less than 10%, less than 10%, etc.).

Partially reflective mirror 146 (e.g., a metal mirror or other mirror) may sometimes be referred to as beam splitter 146, half mirror (HM) 146, partially reflective layer 146, etc. Partially reflective layer 146 may have a reflectance that is greater than 20%, greater than 40%, less than 80%, less than 60%, between 40% and 60%, etc.

Reflective layer 148 may have a reflectance that is greater than 80%, greater than 90%, greater than 95%, greater than 99%, etc. Reflective layer 148 may have a surface with concave curvature that receives light 108 from display 18 through tunable lens 72-2 and partially reflective layer 146 and reflects the light back towards the partially reflective layer. The light reflected by reflective layer 148 may then reflect off partially reflective layer 146 towards viewer 102.

As shown in FIG. 14, the viewer may also receive light 144 from a physical object 142 in the viewer's physical environment. Light 144 may pass through partially reflective layer 146 to reach viewer 102.

In FIG. 14, tunable lens 72-2 focuses light from display 18 without focusing real world light 144 from the viewer's physical environment. This example is merely illustrative and tunable lens 72-2 may optionally focus the real world light 144 instead or in addition to the light from display 18. In general, tunable lens 72-2 may be positioned at any point within the optical path of light 108 and/or light 144. For example, the tunable lens 72-2 may be interposed between partially reflective layer 146 and reflective layer 148. In this case, the light may make multiple passes through the tunable lens.

In another possible arrangement, shown in FIG. 15, optical module 70 may include a display 18, tunable lens 72-2, and partially reflective layer 146. Display 18 may emit light 108 through lens elements 72-2 towards partially reflective layer 146. Display 18 may be opaque (e.g., with a transparency that is less than 40%, less than 20%, less than 10%, less than 10%, etc.). Partially reflective mirror 146 (e.g., a metal mirror or other mirror) may sometimes be referred to as beam splitter 146, half mirror (HM) 146, partially reflective layer 146, etc. Partially reflective layer 146 may have a reflectance that is greater than 20%, greater than 40%, less than 80%, less than 60%, between 40% and 60%, etc. Partially reflective layer 146 may have curved surfaces if desired.

Light 108 therefore passes through tunable lens 72-2 and is reflected by partially reflective layer 146 towards viewer 102. As shown in FIG. 15, the viewer may also receive light 144 from a physical object 142 in the viewer's physical environment. Light 144 may pass through partially reflective layer 146 to reach viewer 102.

In each one of FIGS. 14 and 15, tunable lens 72-2 may be adjusted between different negative optical powers, may be adjusted between different positive optical powers, or may be adjusted between both positive and negative optical powers.

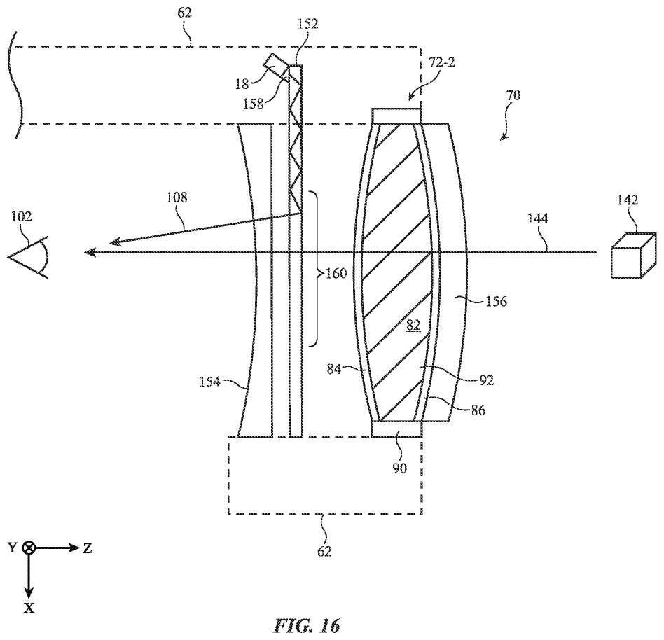

A tunable lens may be incorporated into an optical module that includes a waveguide. Examples of this type are shown in FIGS. 16-18. The optical module may include an input coupler 158, a waveguide 152, an output coupler 160, a negative bias lens 154, a tunable positive bias lens 72-2, and a cover layer 156.

Display 18 may be used to create an image for viewer 102 (e.g., eye 102). Display 18 may be formed by a digital mirror device, a liquid-crystal-on-silicon device, a scanning microelectromechanical systems mirror device, another reflective display device, or any other display type.

Input coupler 158 (e.g., prisms, holograms, etc.) may be used to couple images from display 18 into waveguide 152. Light 108 from the images may be guided within waveguide 152 in accordance with the principal of total internal reflection. In this way, the image may be transported from the side of device 10 towards the center of device 10 (e.g., in the negative Z-direction in FIG. 16) to a position that is aligned with the viewer's eye 102. Waveguide 152 may be provided with an output coupler 160 such as holograms formed on or in the material of waveguide 152. The output coupler 160 may couple the images from the waveguide 152 towards the viewer. This allows a user to view a computer-generated image (display image) overlaid over real-world objects such as real-world object 142. In other words, the viewer receives both light 108 from display 18 (via waveguide 152) and light 144 from physical objects such as physical object 142.

Tunable positive bias lens 72-2 may be interposed between the front (outwardly facing) side of device 10 and waveguide 152 (e.g., between real-world object 142 and waveguide 152). Tunable positive bias lens 72-2 may apply a positive optical power to light traveling in the negative Z-direction. Negative bias lens 154 may be interposed between waveguide 152 and the rear (inwardly facing) side of device 10 (e.g., between waveguide 152 and viewer 102). Negative bias lens 154 may apply a negative optical power to light traveling in the negative Z-direction.

Tunable lens 72-2 may have the arrangement of FIGS. 4 and 5 or any other desired arrangement. In FIG. 16, tunable lens 72-2 is formed directly adjacent to cover layer 156. Cover layer 156 may be formed from glass or plastic. Cover layer 156 may have first and second opposing surfaces, with the first surface forming an exterior surface of device 10 and the second surface directly contacting tunable lens 72-2.

In FIG. 16, the curvature of lens element 84 may be adjusted in tunable lens 72-2. In one possible arrangement, shown in FIG. 16, cover layer 156 directly contacts lens element 86 of tunable lens 72-2. In other words, lens element 86 has a first side that directly contacts cover layer 156 and a second, opposing side that partially defines fluid-filled chamber 82 and directly contacts fluid 92. Alternatively, lens element 86 may be omitted and cover layer 156 may partially define fluid-filled chamber 82 and directly contact fluid 92.

In some situations, the powers of bias lenses 154 and 72-2 may be complementary. For example, bias lens 72-2 may have a positive lens power such as 1.5 diopter and bias lens 154 may have a negative lens power such as a −1.5 diopter. With this type of arrangement, the positive power of lens 72-2 is cancelled by the corresponding negative power of lens 154, so that the net effect is as if there were no lens present between the real-world objects and viewer 102 (e.g., real-world image experiences a zero lens power from lenses 72-2 and 154 when traveling to viewer 102). At the same time, the negative power of lens 154 is applied to the images from display 18 that exit waveguide 152 and travel through lens 154 to reach viewer 102.

Tunable lens 72-2 may be adjusted between different negative optical powers, may be adjusted between different positive optical powers, or may be adjusted between both positive and negative optical powers. When tunable lens 72-2 is set to a positive optical power of the same magnitude as the negative optical power applied by negative bias lens 154, the net optical power applied to the real world light by lenses 72-2 and 154 is 0. When tunable lens 72-2 is set to a positive optical power of a lower magnitude than the negative optical power applied by negative bias lens 154, the net optical power applied to the real world light by lenses 72-2 and 154 is negative. When tunable lens 72-2 is set to a negative optical power, the net optical power applied to the real world light by lenses 72-2 and 154 is negative. When tunable lens 72-2 is set to a positive optical power of a higher magnitude than the negative optical power applied by negative bias lens 154, the net optical power applied to the real world light by lenses 72-2 and 154 is positive.

In this way, tunable lens 72-2 in FIG. 16 may be adjusted to selectively focus the real world image light 144 (e.g., from physical object 142).

FIG. 16 shows how one or more components in the optical module may be coupled to support structures 62. Support structures 62 may be coupled to any of the components in any of the optical modules of FIGS. 6-18.

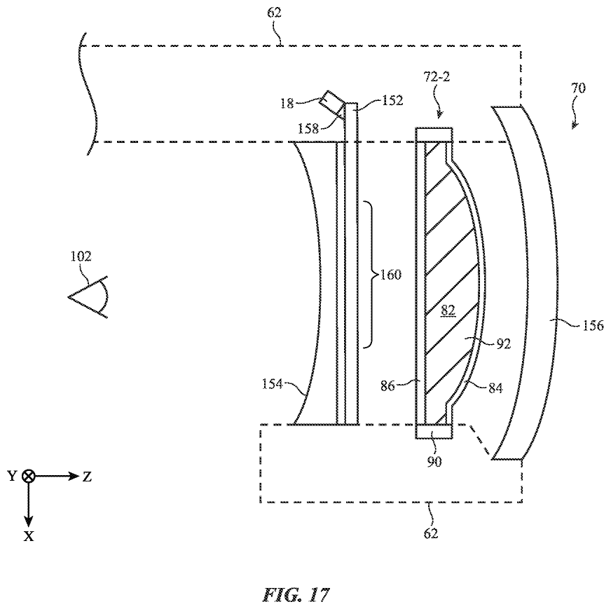

In the example of FIG. 16, adjustable positive bias lens 72-2 is formed adjacent to cover layer 156. Alternatively, as shown in FIG. 17, there may be an air gap between tunable lens 72-2 and cover layer 156. The arrangement of FIG. 17 is otherwise the same as the arrangement of FIG. 16.

In the example of FIGS. 16 and 17, negative bias lens 154 is non-adjustable whereas the positive bias lens is formed using tunable lens 72-2. The opposite arrangement may instead be used if desired, with an adjustable negative bias lens used in the same optical module as a non-adjustable positive bias lens.

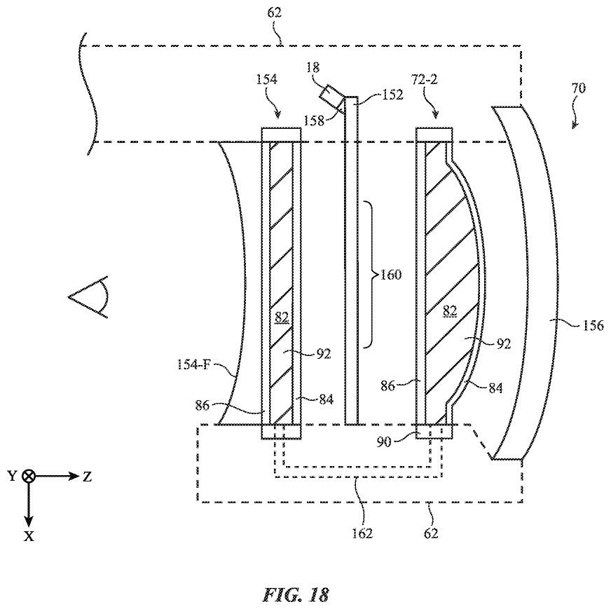

Alternatively, as shown in FIG. 18, the optical module 70 may include both an adjustable negative bias lens 154 and an adjustable positive bias lens 72-2. Each one of adjustable negative bias lens 154 and adjustable positive bias lens 72-2 may have the arrangement of tunable lens 72-2 in FIGS. 4 and 5 or any other desired arrangement.

In FIG. 18, adjustable negative bias lens 154 includes a fluid-filled chamber 82 defined by lens elements 84 and 86 that is filled with fluid 92 and that includes lens housing structures 90. Adjustable negative bias lens 154 in FIG. 18 additionally includes a fixed (non-adjustable) lens clement 154-F with a concave curved surface. Fixed lens element 154-F may be formed from a single piece of plastic or glass, as examples.

In one example, adjustable negative bias lens 154 may be adjusted between different negative optical powers whereas adjustable positive bias lens 72-2 may be adjusted between different positive optical powers.

Adjustable negative bias lens 154 and adjustable positive bias lens 72-2 may be controlled individually (e.g., by control circuitry 14) in one possible embodiment. In other words, the adjustable negative bias lens 154 may be adjusted to change the optical power provided by adjustable negative bias lens 154 without changing the optical power provided by adjustable positive bias lens 72-2. Similarly, the adjustable positive bias lens 72-2 may be adjusted to change the optical power provided by adjustable positive bias lens 72-2 without changing the optical power provided by adjustable negative bias lens 154.

Alternatively, there may optionally be a channel such as channel 162 that connects the fluid-filled chamber for adjustable negative bias lens 154 with the fluid-filled chamber for adjustable positive bias lens 72-2. When channel 162 is included, fluid may move between the two chambers through the channel. When channel 162 is included, controlling a single adjustable lens element in either one of lenses 154 and 72-2 may change the shape of both the adjustable negative bias lens 154 and adjustable positive bias lens 72-2. In other words, the adjustable negative bias lens and the adjustable positive bias lens are adjusted synchronously.

For example, adjusting the shape of lens element 84 in adjustable positive bias lens 72-2 may, in addition to changing the shape (and optical power of) adjustable positive bias lens 72-2, change the shape (and optical power of) adjustable negative bias lens 154 (more specifically lens element 84 in adjustable negative bias lens 154). The opposite arrangement may also be used, with adjusting the shape of lens element 84 in adjustable negative bias lens 154 also changing the shape (and optical power of) adjustable positive bias lens 72-2 (more specifically lens element 84 in adjustable positive bias lens 72-2).

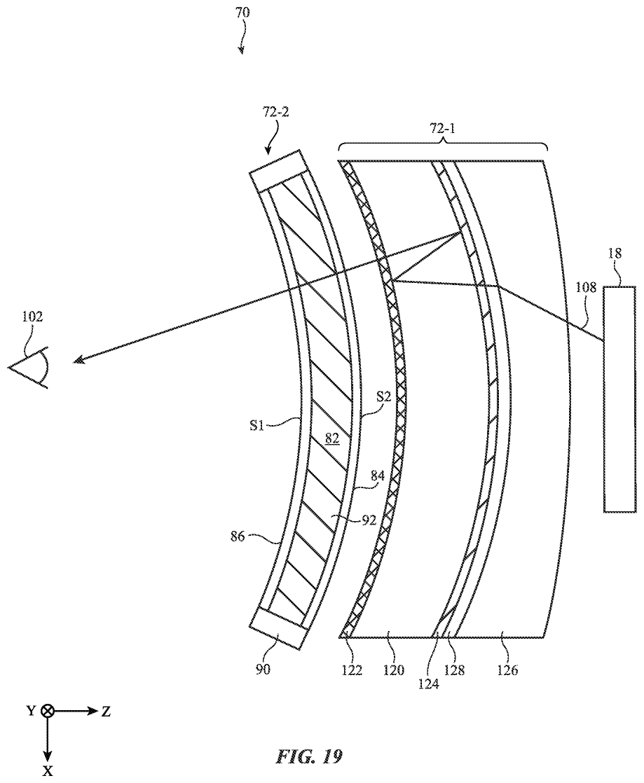

FIG. 19 is a side view of an optical module 70 with a lens module that includes a tunable lens 72-2 and a catadioptric lens element 72-1 that is non-adjustable. Tunable lens 72-2 may have the arrangement of FIGS. 4 and 5 or any other desired arrangement. The optical module also includes a display 18. Display 18 may emit light through lens elements 72-1 and 72-2 towards viewer 102 (e.g., a viewer's eye, sometimes referred to as an eye-box). Display 18 may be opaque (e.g., with a transparency that is less than 40%, less than 20%, less than 10%, less than 10%, etc.).

In the example of FIG. 19, catadioptric lens 72-1 includes lens elements 120 and 126, a partially reflective layer 128 between lens elements 120 and 126, a quarter wave plate 124 between lens element 120 and partially reflective layer 128, and a reflective polarizer 122. These optical structures may allow light rays from display 18 to pass through and/or reflect from surfaces in lens 72-1, thereby providing a desired lens power. FIG. 19 shows a path for light 108 that is emitted by display 18 in the negative Z-direction, passes through partially reflective layer 128, reflects off reflective polarizer 122 in the positive Z-direction, reflects off partially reflective layer 128 in the negative Z-direction, and then passes through reflective polarizer 122 in the negative Z-direction.

In the example of FIG. 19, lens element 126 has a convex surface that faces display 18 and a concave surface that faces viewer 102 and lens element 120 has a convex surface that faces display 18 and a concave surface that faces viewer 102. As shown in FIG. 19, a partially reflective mirror (e.g., a metal mirror coating or other mirror coating such as a dielectric multilayer coating with a 50% transmission and a 50% reflection) such as partially reflective mirror 128 may be formed on the concave surface of lens element 126. Partially reflective mirror 128 may sometimes be referred to as beam splitter 128, half mirror (HM) 128, partially reflective layer 128, etc. Partially reflective layer 128 may have a reflectance that is greater than 20%, greater than 40%, less than 80%, less than 60%, between 40% and 60%, etc.

A wave plate such as wave plate 124 may be formed on the convex surface of lens clement 120 between lens clement 120 and partially reflective layer 128. Wave plate 124 may be attached to lens element 120 (e.g., using an optically clear adhesive layer or via coating directly to the lens element without an intervening adhesive layer). Wave plate 124 (sometimes referred to as retarder 124, quarter wave plate (QWP) 124, etc.) may be a quarter wave plate that conforms to the convex surface of lens element 120. Retarder 124 may be a coating on the convex surface of lens element 120. These examples are merely illustrative and wave plate 124 may instead optionally be attached or coated to the concave surface of lens element 120.

Reflective polarizer 122 may be attached to the concave surface of lens element 120. Reflective polarizer 122 may have orthogonal reflection and pass axes. Light that is polarized parallel to the reflection axis of reflective polarizer 122 will be reflected by reflective polarizer 122. Light that is polarized perpendicular to the reflection axis and therefore parallel to the pass axis of reflective polarizer 122 will pass through reflective polarizer 122. Reflective polarizer 122 may sometimes be referred to as an advanced polarization film (APF).

In the example of FIG. 19, lens elements 120 and 126 each have one convex surface and one concave surface. This example is merely illustrative and in general each surface of each lens clement may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface. Different surfaces of the same lens element may have different radii of curvature. Different surfaces of different lens elements may have different radii of curvature. Each one of lens elements 120 and 126 may be formed from a transparent material such as plastic or glass.

Additional optical layers may be incorporated into catadioptric lens element 72-1 if desired. As a specific example, a linear polarizer may be included (e.g., between reflective polarizer 122 and tunable lens element 72-2).

In FIG. 19, catadioptric lens element 72-1 is interposed between display 18 and tunable lens 72-2. This example is merely illustrative and lens elements 72-1 and 72-2 may be switched if desired (e.g., such that tunable lens element 72-2 is interposed between catadioptric lens element 72-1 and display 18).

The catadioptric lens element 72-1 in FIG. 19 may magnify the images from display 18 for viewer 102. In other words, catadioptric lens element 72-1 may have a positive optical power that is fixed. Tunable lens 72-2 may be adjusted between any desired optical powers. The optical power of tunable lens 72-2 may be adjusted between different negative optical powers, may be adjusted between different positive optical powers, or may be adjusted between both positive and negative optical powers.

In the example of FIG. 19, tunable lens 72-2 has a lens element 86 with an aspheric concave surface S1. The curvature of surface SI may be fixed. Tunable lens 72-2 also has a lens element 84 with a convex surface S2 that has adjustable curvature. Adjusting the curvature of surface S2 of the tunable lens 72-2 may set the total optical power of optical module 70 within a range of −6 Diopters and +3 Diopters (as one example).

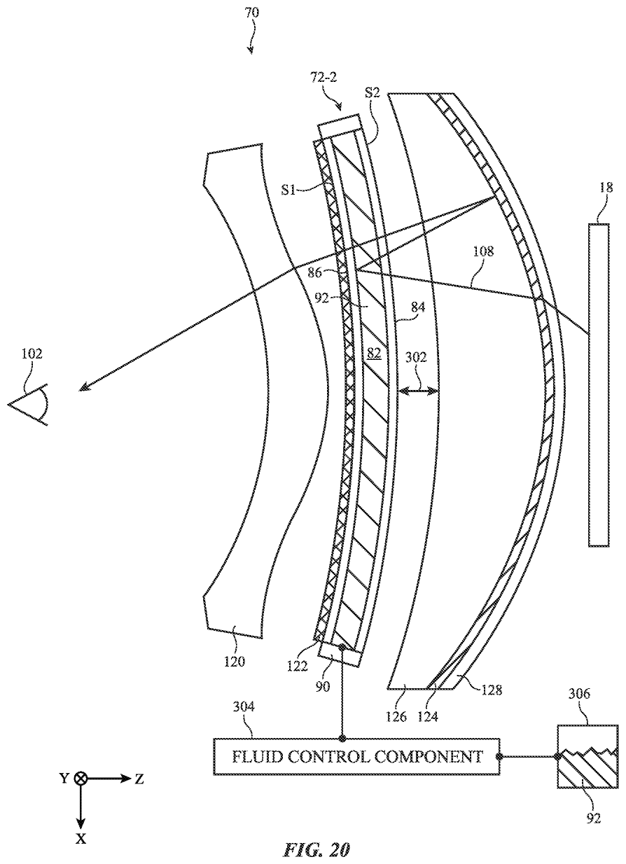

In another embodiment, shown in FIG. 20, tunable lens 72-2 may be incorporated into a catadioptric lens module with multiple lens elements. As shown in FIG. 20, optical module 70 includes a tunable lens 72-2 that is interposed between lens elements 120 and 126. Lens element 126 has a convex surface that faces display 18 and a concave surface that faces viewer 102. Lens element 120 has a convex surface that faces display 18 and a concave surface that faces viewer 102. Tunable lens 72-2 has a lens element 86 with an aspheric concave surface S1. The curvature of surface S1 may be fixed. Tunable lens 72-2 also has a lens element 84 with a convex surface S2 that has adjustable curvature.

In the example of FIG. 20, partially reflective layer 128 is formed on the convex surface of lens element 126 and reflective polarizer 122 is formed on the concave surface SI of lens element 86 in tunable lens 72-2. A quarter wave plate 124 is interposed between lens element 126 and partially reflective layer 128. The location of the quarter wave plate in FIG. 20 is merely illustrative. The quarter wave plate may alternatively be formed on the concave surface of lens element 126, on the convex surface S2 of tunable lens 72-2, or on the concave surface S1 of tunable lens 72-2.

FIG. 20 further shows how there may be an air gap 302 between tunable lens 72-2 and lens element 126. FIG. 20 shows a path for light 108 that is emitted by display 18 in the negative Z-direction, passes through partially reflective layer 128, lens element 126, air gap 302, and tunable lens 72-2, reflects off reflective polarizer 122 in the positive Z-direction, passes through tunable lens 72-2, air gap 302, and lens element 126, reflects off partially reflective layer 128 in the negative Z-direction, and then passes through lens element 126, air gap 302, tunable lens 72-2, reflective polarizer 122, and lens clement 120 in the negative Z-direction. The light therefore makes three passes through tunable lens 72-2 between being emitted by display 18 and reaching viewer 102. This effectively triples the optical power provided by adjustable surface S2 in tunable lens 72-2, allowing for the total thickness of tunable lens 72-2 to be mitigated while achieving a target optical power range for optical module 70.

FIG. 20 shows how further control of the shape of surface S2 in tunable lens 72-2 may be achieved by adjusting the amount of fluid 92 in fluid-filled chamber 82. As shown in FIG. 20, a fluid control component 304 may be connected between fluid-filled chamber 82 and a fluid reservoir 306 that includes additional fluid 92. The fluid control component 304 may adjust the volume of fluid 92 that is included in fluid-filled chamber 82. Adjusting the amount of volume in the fluid-filled chamber may change the curvature of surface S2.

There may be one or more fluid channels between fluid-filled chamber 82 and reservoir 306 that allow fluid control component 304 to control the amount of fluid in fluid-filled chamber 82. Fluid control component 304 may be a pump, stepper motor, piezoelectric actuator, shape memory alloy (SMA), motor, hydraulic actuator, linear electromagnetic actuator, and/or other electronic component that applies a force to the fluid 92.

As one example, the magnitude of the fluid in fluid-filled chamber 82 may be used to adjust a spherical optical power provided by tunable lens 72-2 and edge actuation along a periphery of the tunable lens may be used to adjust a cylindrical optical power provided by tunable lens 72-2.

In the example of FIG. 20, there may be an air gap between tunable lens 72-2 and lens element 126 as well as an air gap between tunable lens 72-2 and lens element 120. This example is merely illustrative and one or both of these air gaps may be omitted if desired (e.g., tunable lens 72-2 may be directly bonded to lens elements 120 and/or 126 or there may be a low-index filler between tunable lens 72-2 and lens elements 120 and/or 126).

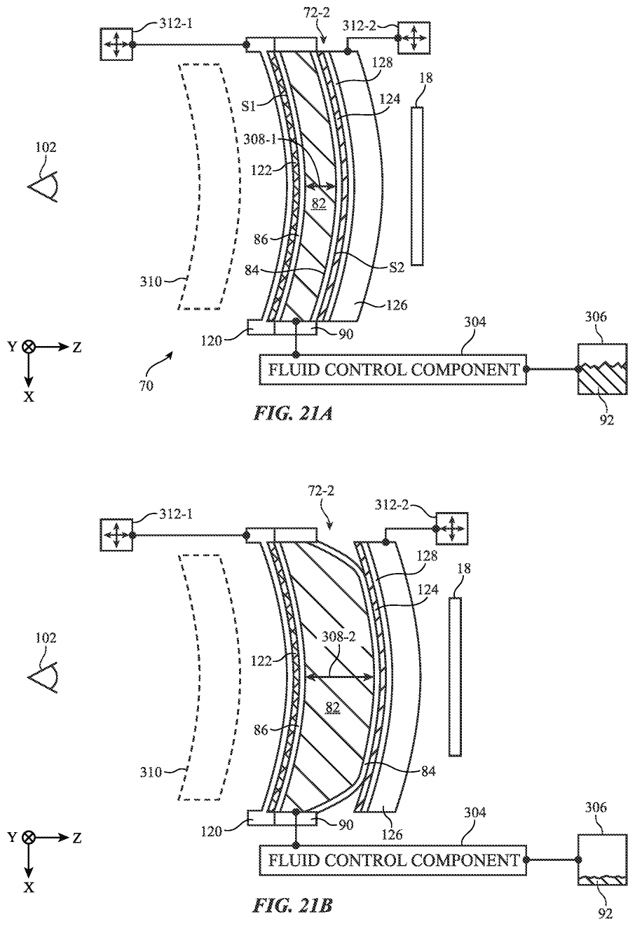

FIGS. 21A and 21B show an optical module where the amount of fluid in a fluid-filled chamber of a tunable lens is used to adjust the spherical optical power of the lens module. As shown in FIG. 21A, optical module 70 may include a tunable lens 72-2 that is interposed between lens elements 126 and 120. Lens element 126 has a convex surface that faces display 18 and a concave surface that faces viewer 102. Lens element 120 has a convex surface that faces display 18 and a concave surface that faces viewer 102. Tunable lens 72-2 has a lens element 86 with an aspheric concave surface S1. The curvature of surface SI may be fixed. Tunable lens 72-2 also has a lens element 84 with a convex surface S2.

In the examples of FIGS. 21A and 21B, partially reflective layer 128 is formed on the concave surface of lens element 126 and reflective polarizer 122 is formed on the concave surface S1 of lens element 86 in tunable lens 72-2. A quarter wave plate 124 is interposed between partially reflective layer 128 and lens element 84. The location of the quarter wave plate in FIGS. 21A and 21B is merely illustrative. The quarter wave plate may alternatively be formed on the concave surface of lens element 86.

In FIGS. 21A and 21B, the amount of fluid in fluid-filled chamber 82 may be adjusted to change the spherical power provided by the tunable lens. As shown in FIG. 21A, a fluid control component 304 may be connected between fluid-filled chamber 82 and a fluid reservoir 306 that includes additional fluid 92. The fluid control component 304 may adjust the volume of fluid 92 that is included in fluid-filled chamber 82. There may be one or more fluid channels between fluid-filled chamber 82 and reservoir 306 that allow fluid control component 304 to control the amount of fluid in fluid-filled chamber 82. Fluid control component 304 may be a pump, stepper motor, piezoelectric actuator, shape memory alloy (SMA), motor, hydraulic actuator, linear electromagnetic actuator, and/or other electronic component that applies a force to the fluid 92.

Adjusting the amount of volume in the fluid-filled chamber may change the thickness of fluid-filled chamber 82. In FIG. 21A, the fluid-filled chamber has a first thickness 308-1 that is associated with a minimum spherical optical power (e.g., −10.5 Diopters). In FIG. 21B, the fluid control component 304 has pumped additional fluid 92 from reservoir 306 into chamber 82, causing the chamber to have an increased thickness 308-2. In FIG. 21B, the fluid-filled chamber has a second thickness 308-2 that is associated with a maximum spherical optical power (e.g., +6.5 Diopters).

The range in spherical optical power provided by tunable lens 72-2 may be at least 10Diopter, at least 15 Diopter, at least 17 Diopter, etc. The total change in thickness between the minimum thickness of chamber 82 (in FIG. 21A) and the maximum thickness of chamber 82 (in FIG. 21B) may be at least 0.5 millimeters, at least 1.0 millimeters, at least 1.2 millimeters, etc.

Adjusting the thickness of chamber 82 may adjust the spherical optical power provided by tunable lens 72-2. To adjust the cylindrical optical power provided by the lens module, an additional lens element 310 may optionally be included between lens element 120 and viewer 102. Instead or in addition, the optical module may include one or more computer-controlled positioners that are configured to rotate lens element 126 relative to lens element 120. In the example of FIGS. 21A and 21B, a first computer-controlled positioner 312-1 is coupled to lens element 120 and is configured to rotate lens element 120 within the YX-plane whereas a second computer-controlled positioner 312-2 is coupled to lens element 126 and is configured to rotate lens element 126 within the YX-plane. Rotating lens elements 120 and 126 relative to one another may adjust the total cylindrical optical power provided by lens module 72.

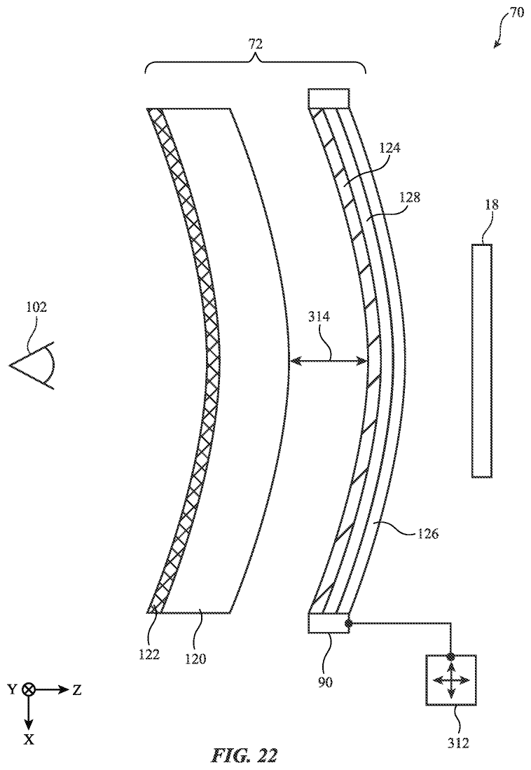

In another possible arrangement, shown in FIG. 22, the shape and/or position of partially reflective layer 128 is adjusted to change the spherical and/or cylindrical optical power provided by the lens module. In the example of FIG. 22, lens module 72 includes a lens element 126 and a lens element 120. Lens element 126 has a convex surface facing display 18 and a concave surface facing viewer 102. Lens element 120 has a convex surface facing display 18 and a concave surface facing viewer 102. Partially reflective layer 128 is attached to the concave surface of lens element 126. Reflective polarizer 122 is attached to the concave surface of lens element 120. Quarter wave plate 124 is depicted as being attached to partially reflective layer 128 at the concave side of lens element 126. This example is merely illustrative. Quarter wave plate 124 may optionally be attached to the convex surface of lens element 120 or the concave surface of lens element 120 if desired.

As shown in FIG. 22, lens element 126 may be attached to a computer-controlled positioner 312. The computer-controlled positioner 312 may adjust the size of a gap 314 between QWP 124/partially reflective layer 128/lens element 126 and lens element 120. In other words, computer-controlled positioner 312 may shift the position of partially reflective layer 128 along the Z-direction to adjust the spherical optical power provided by lens module 72. Computer-controlled positioner 312 may shift the partially reflective layer laterally without adjusting the curvature of the partially reflective layer.

Instead or in addition to adjusting the lateral position of partially reflective layer 128, one or more actuators 90 may be positioned around the periphery of the partially reflective layer 128 to adjust a curvature of partially reflective layer 128. Similar to as shown and discussed in connection with the tunable lens in FIGS. 4 and 5, the actuators may selectively bias partially reflective layer 128 and/or lens clement 126 at one or more points along the periphery of the reflective layer 128 and/or lens element 126 in order to selectively bend the reflective layer 128 and lens element 126. Selectively bending the partially reflective layer may adjust the direction of an axis of cylindrical optical power and/or a magnitude of the cylindrical optical power.

In one illustrative arrangement, lens clement 126 in FIG. 22 is a semi-rigid lens element formed from polycarbonate. In general, each one of the lens elements in FIGS. 6-22 may be elastomeric, semi-rigid, or rigid.

In the example of FIG. 22, the gap between lens element 120 and wave plate 124 may be air-filled or may be filled with a low-index filler.

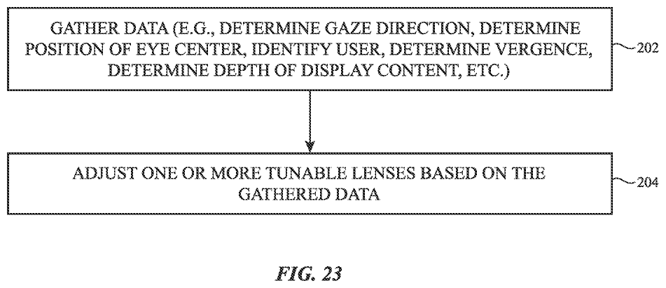

FIG. 23 is a flowchart of an illustrative method of operating a head-mounted device 10 with a tunable lens (e.g., any of the tunable lenses of FIGS. 6-22). At step 202, the head-mounted device may gather data. The data may be gathered from external equipment 60, from one or more sensors in device 10, from one or more output devices in device 10, etc.

Head-mounted device 10 may wirelessly receive information from external equipment 60 at step 202. The information received from external equipment may, for example, indicate if the user is actively viewing the external equipment and/or a distance between the external equipment and the head-mounted device. The information received may include raw data (e.g., accelerometer data indicating a raise-to-wake gesture) and/or a notification that the external equipment is being actively viewed (without necessarily including raw data). External equipment 60 may estimate the distance between head-mounted device 10 and the external equipment using ultra-wideband (UWB) communications and/or depth sensing (e.g., using a LIDAR sensor in the external equipment).

Head-mounted device 10 may gather data from one or more sensors at step 202. The sensors used to gather data at step 202 may include inward-facing camera 22, outward-facing camera 24, microphone 26, position and motion sensors 28, ambient light sensor 30, magnetometer 32, heart rate monitor 34, depth sensor 36, temperature sensor 38, touch sensor 40, moisture sensor 42, gas sensor 44, barometer 46, gaze-tracking sensor 48, button 50, light-based proximity sensor 52, GPS sensor 54, etc.

Head-mounted device 10 may gather data associated with one or more output devices at step 202. The data associated with an output device may include information on whether or not that output device is powered on and/or the type of content being presented if the output device is powered on. For example, the data gathered at step 202 may include information on whether display 18 in head-mounted device 10 is operating and what type of content is being presented on display 18 (e.g., the depth of content presented by display 18). The depth of content presented by display 18 may be adjusted by changing the virtual image distance (VID) (e.g., through optics, light field, etc.) and/or by rendering a difference in binocular disparity while keeping the VID the same. The content may be in a plane or three-dimensions, may have multiple depths, and may be of a variety of types including text, UI, graphics, etc.

The data gathered at step 202 may additionally include information on the number and/or type of applications installed on head-mounted device 10, the number and/or type of applications currently running on head-mounted device 10, information from an application running on head-mounted device 10, etc. Depending on the type of application or the content of the application, the tunable lens may be adjusted to any preferred settings.

The data gathered at step 202 may include any other desired information (e.g., the time of day, the length of time the head-mounted device 10 has been operated, calendar information for the user of the head-mounted device, etc.).

Gathering data at step 202 may further include monitoring one or more additional components of head-mounted device 10. For example, information from one or more passthrough cameras, one or more adjustable tint layers and/or adjustable transparency layers, one or more speakers, etc. may be monitored at step 202. Any adjustments to one of these components (e.g., an adjustment to an operating setting of the passthrough camera, an adjustment to the transparency of an adjustable transparency layer, etc.) may be gathered at step 202 and subsequently used to update the tunable lens and/or other system components.

In general, any of these types of data may influence adjustments of tunable lens 72-2.

Next, at step 204, head-mounted device 10 may adjust the tunable lens (e.g., tunable lens 72-2 based on the gathered data). Adjusting the tunable lens may include increasing the optical power provided by the tunable lens, decreasing the optical power provided by the tunable lens, changing the lens center from a first position to a second position within the plane of the lens, and/or any other desired adjustments to the tunable lens. The tunable lens may be adjusted to provide full prescription correction to the user wearing the head-mounted device (e.g., covering both spherical and cylindrical corrections).

Other components within head-mounted device 10 may be adjusted at step 204. For example, the data gathered at step 202 may cause an update to a passthrough camera, an adjustable tint layer, an adjustable transparency layer, a speaker, or any other desired component within head-mounted device 10.

As a specific example, gaze-tracking sensor 48 may be used to determine a user's gaze direction at step 202. The user's gaze direction may indicate where in the physical environment the user is focused (e.g., at a relatively close distance or at a relatively far distance) and the tunable lens may be updated accordingly at step 204.

As another example, gaze-tracking sensor 48 may be used to determine the position of the center of the user's eye at step 202. The position of the user's eye (e.g., the user's pupil center) may be used to adjust the tunable lens at step 204 to compensate for geometric distortion associated with one or more lenses in optical module 70 or any other optical artifacts (e.g., chromatic aberrations, non-uniformities, vignetting).

As another example, gaze-tracking sensor 48 may be used to determine the vergence of the user's eye at step 202. The vergence of the user's eye may be used to adjust the tunable lens at step 204 to compensate for the user's presbyopia, prism correction, etc. The vergence signal may also feed into the rendered content depth by either adjusting the binocular disparity or VID if there is any displayed content.

As another example, one or more sensors or input components in device 10 may be used to identify the user operating device 10. The user operating device 10 may be identified using the gaze-tracking sensor, a fingerprint sensor, and/or any other desired sensors within device 10. Instead or in addition, the user operating device 10 may be assumed to be a user associated with an account that is logged in on device 10. The user may have a known preferred state for the tunable lens. Accordingly, the identity of the user operating the device may be used to adjust the tunable lens at step 204 (e.g., to place the tunable lens in the known preferred state for that user).

As another example, at step 202 control circuitry 14 may receive information regarding the depth of the content that is presented by display 18. When the depth of the content on display 18 is relatively short, the user may be assumed to be focused at a relatively short depth. When the depth of the content on display 18 is relatively long, the user may be assumed to be focused at a relatively long depth. At step 204 the tunable lens may be updated based on the depth of the content on display 18.

In general, any of the eye tracked signals may change the state of the tunable lens to improve acuity and comfort. As examples, the vergence signal, with or without any displayed content may be used to drive the tunable lens to a state so the user can see the real world clearly either directly in an AR system or through a combination of passthrough camera and display focus adjustments.

The foregoing is merely illustrative and various modifications can be made to the described embodiments. The foregoing embodiments may be implemented individually or in any combination.

What is claimed is:

1. An electronic device, comprising:
a head-mounted support structure; and
an optical module coupled to the head-mounted support structure, wherein the optical module comprises:
a waveguide having first and second opposing sides;
a display that is configured to emit light into the waveguide;
a negative bias lens on the first side of the waveguide; and
an adjustable positive bias lens on the second side of the waveguide.

2. The electronic device defined in claim 1, wherein the negative bias lens is a non-adjustable negative bias lens.

3. The electronic device defined in claim 1, wherein the negative bias lens is an adjustable negative bias lens.

4. The electronic device defined in claim 3, wherein the adjustable positive bias lens and the adjustable negative bias lens are adjusted independently.

5. The electronic device defined in claim 3, wherein the adjustable positive bias lens and the adjustable negative bias lens are adjusted synchronously.

6. The electronic device defined in claim 3, wherein the adjustable negative bias lens comprises a tunable lens element with a fluid-filled chamber.

7. The electronic device defined in claim 6, wherein the adjustable negative bias lens further comprises a non-adjustable lens element with a surface having concave curvature.

8. The electronic device defined in claim 1, wherein the optical module further comprises a cover layer that is in direct contact with the adjustable positive bias lens.

9. The electronic device defined in claim 1, wherein the optical module further comprises a cover layer that is separated from the adjustable positive bias lens by an air gap.

10. The electronic device defined in claim 1, wherein the optical module further comprises:
an input coupler that couples the light from the display into the waveguide; and
an output coupler that couples the light from the display out of the waveguide.

11. The electronic device defined in claim 1, wherein the negative bias lens comprises third and fourth opposing sides, wherein the third side is interposed between the waveguide and the fourth side, and wherein the fourth side has a surface with concave curvature.

12. The electronic device defined in claim 1, wherein the adjustable positive bias lens comprises a fluid-filled chamber.

13. The electronic device defined in claim 1, further comprising:
a gaze-tracking sensor, wherein the adjustable positive bias lens is configured to be adjusted based on a vergence detected by the gaze-tracking sensor.

14. The electronic device defined in claim 1, further comprising:
a gaze-tracking sensor, wherein the adjustable positive bias lens is configured to be adjusted based on an eye position detected by the gaze-tracking sensor.

15. The electronic device defined in claim 1, wherein the adjustable positive bias lens is configured to be adjusted based on a depth of content presented by the display.

16. The electronic device defined in claim 1, further comprising:
a gaze-tracking sensor, wherein the adjustable positive bias lens is configured to be adjusted based on a gaze direction detected by the gaze-tracking sensor.

17. An electronic device, comprising:
a head-mounted support structure; and
an optical module coupled to the head-mounted support structure, wherein the optical module comprises:
a display;
a partially reflective layer;
a tunable lens element; and
a reflective layer with a surface having concave curvature.

18. The electronic device defined in claim 17, wherein the display is configured to emit light that passes through the tunable lens element and the partially reflective layer, then is reflected by the reflective layer towards the partially reflective layer, and then is reflected by the partially reflective layer towards an eye-box and wherein light from a physical environment is configured to pass through the partially reflective layer towards the eye-box.

19. An electronic device, comprising:
a head-mounted support structure; and
an optical module coupled to the head-mounted support structure, wherein the optical module comprises:
a display;
a partially reflective layer; and
a tunable lens element that is interposed between the display and the partially reflective layer.

20. The electronic device defined in claim 19. wherein the display is configured to emit light that passes through the tunable lens clement and is then reflected by the partially reflective layer towards an eye-box and wherein light from a physical environment is configured to pass through the partially reflective layer towards the eye-box.
